(19) United States
(12) Patent Application Publication
(10) Pub. No.: US 2011/0212321 A1
(43) Pub. Date: Sep. 1, 2011

(54) NANOFIBER ENHANCED FUNCTIONAL FILM MANUFACTURING METHOD USING MELT FILM CASTING

(75) Inventors: Miko Cakmak, Munroe Falls, OH (US); Baris Yalcin, Akron, OH (US); Soumayajit Sarkar, Akron, OH (US)

(73) Assignee: THE UNIVERSITY OF AKRON, Akron, OH (US)

(21) Appl. No.: 12/989,509

(22) PCT Filed: Apr. 27, 2009
(86) PCT No.: PCT/US09/02565

§ 371 Date: May 11, 2011

Related U.S. Application Data
(60) Provisional application No. 61/125,516, filed on Apr. 25, 2008.

(51) Int. Cl. B32B 5/16; B05D 1/12; B82Y 40/00

(52) U.S. Cl. 428/323; 427/180; 977/902

(57) ABSTRACT

The present invention generally relates to a method for producing hybrid materials of thin polymer films with single, laminated, complete and/or partially embedded nanofibers to obtain products with unique functional properties. In one embodiment, the present relates to a hybrid process that utilizes both melt casting and electrospinning to produce nanofiber embedded functional films. In another embodiment, the process of the present invention involves nanofiber-containing products that are formed by producing a plurality of nanofibers via one or more nanofiber producing nozzles; depositing such nanofibers onto a melt cast polymer film; and either partially and/or completely embedding such nanofibers into the melt cast polymer film via one or more electrical forces.

### FIELD OF THE INVENTION

The present invention generally relates to a method for producing hybrid materials of thin polymer films with single, laminated, complete and/or partially embedded nanofibers to obtain products with unique functional properties. In one embodiment, the present relates to a hybrid process that utilizes both melt casting and electrospinning to produce nanofiber embedded functional films. In another embodiment, the process of the present invention involves nanofiber-containing products that are formed by producing a plurality of nanofibers via one or more nanofiber producing nozzles; depositing such nanofibers onto a melt cast polymer film; and either partially and/or completely embedding such nanofibers into the melt cast polymer film via one or more electrical forces. Subsequently, the cast molten film is cooled thereby immobilizing the partially and/or completely embedded nanofibers into the melt cast polymer film. In one embodiment, the nanofibers of the present invention can possess various properties, or functionalities, including, but not limited to, electrical conductivity, transparency and/or bio-functionality.

### BACKGROUND OF THE INVENTION

The melt casting process of polymer films and sheets typically involves extruding a polymer through a film die followed by cooling the extruded film on a chill roll stack and if desired subsequently finishing the product either by stretching in a uniaxial and/or biaxial tenter-frame stretcher followed by annealing. Films ranging from several thousands of microns thick to tens of microns can be produced with very good uniformity.

The technique of electrospinning, also known within the fiber forming industry as electrostatic spinning, of liquids and/or solutions capable of forming fibers, is well known and has been described in a number of patents as well as in the general literature. The process of electrospinning generally involves the creation of an electrical field at the surface of a liquid. The resulting electrical forces create a jet of liquid which carries an electrical charge. These electrically charged jets of liquid may be attracted to a body or other object at a suitable electrical potential. As the liquid jet is forced farther and farther toward the object, it elongates. As it travels away from the liquid reservoir, it steadily dries and hardens, thereby forming a fiber. The drying and hardening of the liquid jet into a fiber may be caused by cooling of the liquid (i.e., where the liquid is normally a solid at room temperature); evaporation of a solvent (e.g., by dehydration); physically induced hardening; or by a curing mechanism (chemically induced hardening). The fibers produced by electrospinning techniques are collected on a suitably located charged receiver and subsequently removed from the receiver as needed.

Fibers produced by the electrospinning process have been used in a wide variety of applications and are known from, for example, U.S. Pat. Nos. 4,043,331 and 4,878,908, to be particularly useful in forming non-woven mats suitable for use in wound dressings. Other medical applications include drug delivery (see, e.g., U.S. Published Patent Application No. 2003/0195611), medical facemasks (see, e.g., WO 01/26610), bandages and sutures that minimize infection rate, blood loss and ultimately dissolve into body. Nanofibers also have promising applications in the area of filtration due to their smaller microporous structure with higher surface area. Electrospun nanofibers are ideal for filtering submicron particles from air or water. They improve filter life and have more contaminant holding capacity. There is a need in the art for a novel method whereby the electrospinning process is combined with the standard melt cast process to produce functional films which incorporates full and/or partially embedded nanofibers.

### SUMMARY OF THE INVENTION

The present invention generally relates to a method for producing hybrid materials of thin polymer films with single, laminated, complete and/or partially embedded nanofibers to obtain products with unique functional properties. In one embodiment, the present relates to a hybrid process that utilizes both melt casting and electrospinning to produce nanofiber embedded functional films. In another embodiment, the process of the present invention involves nanofiber-containing products that are formed by producing a plurality of nanofibers via one or several nanofiber producing nozzles; depositing such nanofibers onto a melt cast polymer film; and either partially and/or completely embedding such nanofibers into the melt cast polymer film via one or more electrical forces. Subsequently, the cast molten film is cooled thereby immobilizing the partially and/or completely embedded nanofibers into the melt cast polymer film. In one embodiment, the nanofibers of the present invention can possess various properties, or functionalities, including, but not limited to, electrical conductivity, transparency and/or bio-functionality.

In one embodiment, the present invention relates to a method for producing a nanofiber-polymer film combination, the method comprising the steps of: (A) producing a polymer film via a melt casting process, wherein the melt cast polymer film is receptive to one or more layers of nanofibers; (B) depositing one or more layers of nanofibers on the melt cast polymer film.

In another embodiment, the present invention relates to a method for producing a nanofiber-polymer film combination, the method comprising the steps of: (a) producing a polymer film via a melt casting process, wherein the melt cast polymer film is receptive to one or more layers of nanofibers; (b) subjecting the melt cast polymer film to at least one heating zone; (c) depositing one or more layers of nanofibers on the melt cast polymer film.

Therefore, it is an object of the present invention to provide methods for integrating electrospinning platforms on commercial melt casting lines in order to fabricate multilayer composite structures of thin polymer films comprising a melt-cast base with one or more layers of electrospun fibers and/or nanofibers embedded and/or coated on such a base layer.

It is an objective of some embodiments of the present invention to describe how solutions are electrospun onto a cast film that is, in one embodiment, located on a flat platform of a commercial melt casting machine to create multilayer structures.

It is another objective of some embodiments of the present invention to provide possible application areas for these products.

It is still another objective of some embodiments of the present invention to provide a continuous process for the mass production of the proposed multilayer films or as-spun nanofiber webs.

### BRIEF DESCRIPTION OF THE DRAWINGS

FIG. 1 is an illustration of a production apparatus for producing multi-functional polymer films in accordance with one embodiment of the present invention;

FIG. 2 illustrates two views of an electrospinning platform that can be utilized in conjunction with the present invention;

FIGS. 3(a) and 3(b) illustrate two additional views of another embodiment of an electrospinning platform that can be utilized in conjunction with the present invention;

FIG. 4(a) illustrates a solution casting machine without an electrospinning portion;

FIG. 4(b) illustrates a solution casting machine in accordance with the embodiment of FIG. 4(a), the solution casting machine having at least two electrospinning platforms of the type depicted in FIG. 2;

FIG. 4(c) is an enlarged view of the dashed circle of FIG. 4(b);

FIG. 5(a) illustrates another embodiment of a solution casting machine without an electrospinning portion;

FIG. 5(b) illustrates a solution casting machine in accordance with the embodiment of FIG. 5(a), the solution casting machine having at least four electrospinning platforms of the type depicted in FIGS. 3(a) and 3(b);

FIG. 6 is a schematic of the nanofiber enhanced functional film line combining melt film casting process with electrospinning;

FIG. 7 is a scanning electron microscope (SEM) image of PAN nanofibers electrospun onto a melt cast Nylon film;

FIG. 8 is a scanning electron microscope (SEM) image of a melt cast Nylon film with PAN nanofibers electrospun thereon;

FIG. 9 is a scanning electron microscope (SEM) image of a cross-section of a Nylon film with PAN nanofibers electrospun thereon;

FIG. 10 is a scanning electron microscope (SEM) image of a melt cast PCL film with PAN nanofibers electrospun thereon;

FIG. 11 is a scanning electron microscope (SEM) image of a cross-section of a PCL film with PAN nanofibers electrospun thereon; and

FIG. 12 is a scanning electron microscope (SEM) image of a melt cast PET film with PAN nanofibers electrospun thereon.

### DETAILED DESCRIPTION OF THE INVENTION

The present invention generally relates to a method for producing hybrid materials of thin polymer films with single, laminated, complete and/or partially embedded nanofibers to obtain products with unique functional properties. In one embodiment, the present relates to a hybrid process that utilizes both melt casting and electrospinning to produce nanofiber embedded functional films. In another embodiment, the process of the present invention involves nanofiber-containing products that are formed by producing a plurality of nanofibers via one or more nanofiber producing nozzles; depositing such nanofibers onto a melt cast polymer film; and either partially and/or completely embedding such nanofibers into the melt cast polymer film via one or more electrical forces. Subsequently, the cast molten film is cooled thereby immobilizing the partially and/or completely embedded nanofibers into the melt cast polymer film. In one embodiment, the nanofibers of the present invention can possess various properties, or functionalities, including, but not limited to, electrical conductivity, transparency and/or bio-functionality.

As used herein the term nanofiber refers to fibers having an average diameter in the range of about 1 nanometer to about 25,000 nanometers (25 microns). In another embodiment, the nanofibers of the present invention are fibers having an average diameter in the range of about 1 nanometer to about 10,000 nanometers, or about 1 nanometer to about 5,000 nanometers, or about 3 nanometers to about 3,000 nanometers, or about 7 nanometers to about 1,000 nanometers, or even about 10 nanometers to about 500 nanometers. In another embodiment, the nanofibers of the present invention are fibers having an average diameter of less than 25,000 nanometers, or less than 10,000 nanometers, or even less than 5,000 nanometers. In still another embodiment, the nanofibers of the present invention are fibers having an average diameter of less than 3,000 nanometers, or less than about 1,000 nanometers, or even less than about 500 nanometers. Additionally, it should be noted that here, as well as elsewhere in the text, ranges may be combined.

In one embodiment of the present invention the aforementioned two technologies, i.e. solution or melt casting and electrospinning technology, are combined in order to fabricate multilayered polymer structures comprising a base of a solution cast film or a melt cast film and one or more layers of spun fibers and/or nanofibers that are positioned in and/or on the solution cast layer, or melt cast layer. The nanofibers can have a chemical composition that is the same or different from the solution cast base layer, or the melt cast base layer. In another embodiment, the nanofibers can have a chemical composition that is the same or different from the solute material that is used in the solution cast base layer. In one instance, the nanofiber material should have a higher melting or glass transition point than that of the polymer used in the melt cast base layer, or solution cast base layer. In the case of a solution cast base layer, the nanofiber material should be insoluble or have limited solubility in the solvent used for solution casting the solution case base film.

The one or more spun layers are, in one embodiment, partially or fully embedded in the solution cast, or melt cast, medium that forms the base layer. The solution cast, or melt cast, base layer may or may not have chemical or physical interaction with the material making up the electrospun nanofibers. Through a variety of chemical and/or physical means, strong bonds can be easily established between the cast base material and the electrospun fibers and/or nanofibers. In one embodiment, the base layer material can be a polymer or a monomer that is ready to be polymerized by a variety of polymerization methods, including photo-polymerization, etc.

Combining the afore-mentioned solution casting, or melt casting, technology with electrospinning is practical and useful not only for fabricating a multilayered thin polymer film but also for improved control over the electrospinning process. Standard electrospinning set-ups generally do not include capabilities for controlling the electrospinning medium (typically air) temperature, pressure and solvent concentration. Health and safety concerns are important to consider, since the vapors emitted from electrospinning solution can be hazardous upon inhalation and should be recovered and disposed of accordingly. Furthermore, challenges still remain to scale up the electrospinning process to continuous mass production while reducing the high cost of the technology. Most of these problems can be eliminated once the electrospinning process is integrated with a solution casting, or melt casting, process.

The present invention also permits the integration of the afore-mentioned technologies, thereby yielding improved control of the processing conditions in electrospinning with an eye towards better product uniformity and mass production in a continuous fashion.

As noted hereinabove, in one embodiment the present invention is directed to the production of multilayer thin polymer films comprising a either a solution cast base layer, or a melt cast base layer and one or more successive layers of electrospun nanofibers of same or varying chemical composition. In another embodiment, the present invention is directed to the production of multilayer polymer films comprising either a solution cast base layer, or a melt cast base layer and electrospun nanofibers either in multilayer configuration or partially or fully embedded form or as one or more successive layers on the base film.

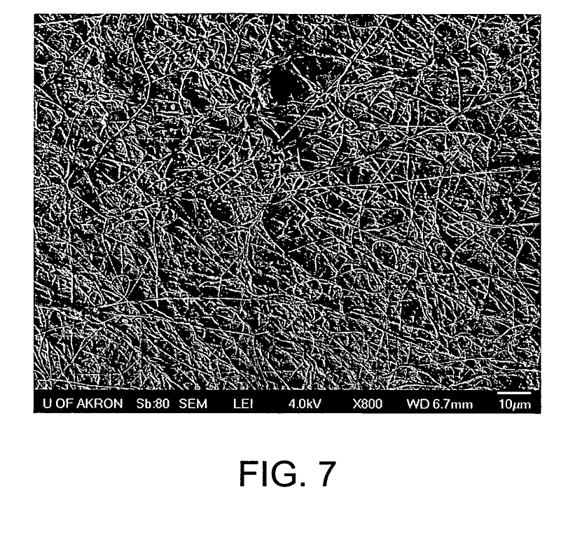

In order to produce the proposed composite structures, the nanofibers can, in one embodiment, be spun directly on a solution, or melt, cast polymer film or monomer film, or even a cast polymer, or monomer, solution, on a rotating endless steel conveyor belt of a solution casting machine, or on a conductive platform, before the three roll stack as illustrated in FIG. 7. In another embodiment, the nanofibers can, in one embodiment, be spun directly on a cast polymer, or monomer, solution, on a rotating endless steel conveyor belt of a solution casting machine, or on a conductive carrier film that is transported along the steel conveyor belt.

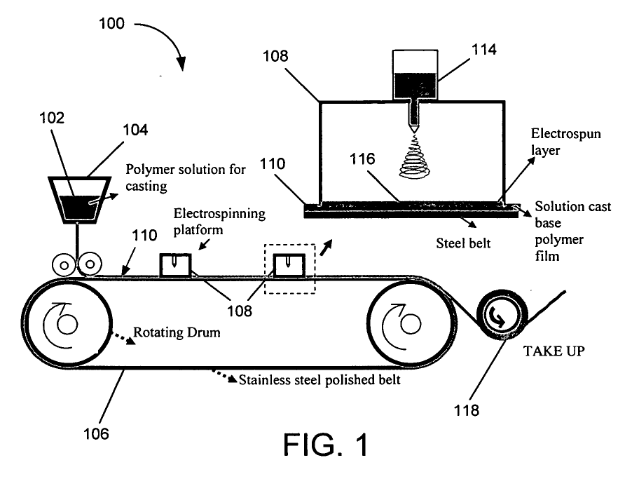

In the embodiment involving direct casting on the steel belt, the grounded receiver would be the conductive steel conveyor belt and the charged liquid would be dispensed from syringes directed towards the conveyor belt of the solution, or melt, casting machine. One possible apparatus 100 for carrying out the present invention is shown in FIG. 1. It should be noted that although FIG. 1 illustrates an embodiment adapted to work with a solution casting process, that the device of FIG. 1 can be modified to work with a melt casting process illustrated in FIG. 7.

Given this, the following discussion of FIGS. 1 through 6 will be directed towards solution casting embodiments. However, as is noted above, the devices of FIGS. 1 through 6 can also be modified based upon the disclosure contained herein (see, e.g., FIG. 7) to be applied to a melt cast polymer base layer.

In the embodiment of FIG. 1, apparatus 100 according to one embodiment of the present invention, comprises a polymer solution 102, for casting, that is contained in any suitable container 104. Polymer solution 102 is first cast, or in some embodiments, a melt cast polymer film is deposited, onto a moving carrier belt 106 of apparatus 100. Optionally, carrier belt 106 can next go through one or more heating zones (not shown) for facilitating solvent evaporation. The heating zones can be formed by any suitable device that can provide localized heat to one or more areas of the solution cast polymer. For example, the heating zones could be formed as heating chambers (e.g., small semi-closed boxes that are kept at one or more elevated temperatures.

Next, as can be seen from FIG. 1, one or more electrospinning platforms 108 are built on apparatus 100 in order to permit for the spinning of one or more nanofibers onto a solution cast, or melt cast, base polymer layer and/or film 110. The nanofibers of the present invention are spun from a suitable nanofiber material 112. In solution cast embodiments, the process is finalized by the removal of the solvent from a film 114 thereby rendering dry hybrid materials comprising a uniform thin base film layer 110 with electrospun fibrous surface structures 116 which can be, for example, collected on an uptake 118. Opportunities for forming multilayered structures using this process are unlimited. If different polymer/solvent mixtures are employed for solution casting and electrospinning, one can manufacture hybrid polymer films with different layers of polymers and morphologies along the thickness direction. If a single polymer/solvent mixture is used in the process, multiple layers of the same polymer with different morphologies, i.e. uniform thin film and fibrous top layers, will be formed along the thickness direction of the film.

In solution cast embodiments, if the polymer used for solution casting is non-conductive (i.e., non-conductive in the electrical sense), as it is typical for most polymers, it is possible to spin the nanofibers on the solution cast film before all the solvent is evaporated. This can be accomplished, in one instance, by spinning the nanofibers on the cast polymer solution prior to entering the major heated zones of the solution casting machine. This set-up/process order ensures that the receiving steel belt remains conductive. This also helps the nanofibers adhere to the layers preceding them. It is also possible to apply the nanofibers on the solution cast film while the film is passing through a set of heating chambers before all the solvent is evaporated.

Since most commercial solution casting machines are designed as completely enclosed systems, it is ideal to have removable access top panels for integration with the electrospinning process. Portable electrospinning platforms can replace these top panels wherever and whenever desired. At times when electrospinning is not desired, and the solution casting machine is to be used for casting thin films only, electrospinning platforms will be removed and top panels are put back into their original locations. It is important that once the electrospinning platforms are in place, they should seal off the machine chamber.

While the present invention is not limited to just one layout, an electrospinning platform will typically accommodate a high voltage source, a high precision pressure/vacuum air pump, one or more large-capacity, air-sealed spinnerets (e.g., a syringe) connected to the pressure/vacuum pumps with flexible tubes and one or more controllers for setting pressure and vacuum levels in the spinnerets. The spinneret is, in one embodiment, mounted on a translation stage (e.g., a linear actuator) which is mounted on the platform. The translation stage allows the spinneret to move horizontally along the width of the carrier belt for positioning the nanofibers uniformly along the width direction of the cast film. The horizontal movement of the translation stage is, in one embodiment, controlled by a laser micrometer. The capability to control pressure/vacuum levels in the spinnerets are, in one embodiment, one important factor of the present invention.

Since the spinnerets are positioned vertical to the carrier belt, dripping of the solution from the syringe needles should be prevented. This can be accomplished by adjustment of the pressure/vacuum levels in the spinnerets throughout the process via any suitable control means. Thus, the present invention may include any suitable control means that permits an operator to control pressure/vacuum levels in the one or more spinnerets. In one embodiment, this control means can be a pressure regulator that is either manually or automatically adjusted (e.g., by a computer control system). If the solution drips from the syringe needle, a vacuum is initially applied to stop the dripping. This is followed by the application of sufficient amount of air pressure to the solution to allow it to spin without dripping. If a sufficient air pressure is not applied to the solution after the initial vacuum, the solution would stop spinning after a while since a vacuum would be generated in the sealed syringe due to the removal of the solution by spinning. As would be known to those of skill in the art, the solution is dispensed at a higher rate under higher voltage. In such a case, the air pressure should also be increased. The force balance acting on the solution in the electrospinning process, (e.g., electrical forces, surface tension, gravity) can be adjusted to render the process dripless by adjusting the pressure/vacuum levels in the sealed spinneret.

In one embodiment, the platform has vertical (z-direction) translation capability. This is desirable because the distance needed between the spinneret and the carrier belt is influenced by the drying rate of the polymer solution. As would be known to those of skill in the art, the drying rate would be different for different polymer/solvent systems. Vertical height adjustment capability of the electrospinning platform allows for a height adjustment between the spinneret and the carrier belt which in turn permits the spinning of different polymer/solvent systems simultaneously at various positions along the length of the device of the present invention. In one embodiment, multiple spinnerets, numbering from 2 to about 1000, can be used in order to increase the production rate. The single die containing multiple needles or small capillaries are connected to the pressure and vacuum pump in order to prevent dripping of the solution.

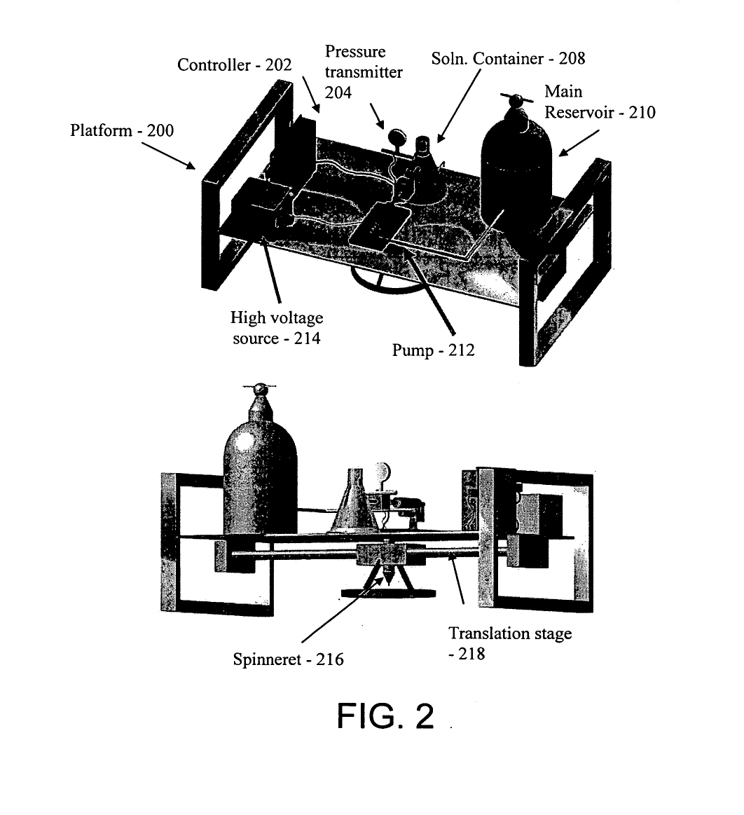

FIG. 2 shows an example electrospinning platform according to one embodiment of the present invention with a single nanofiber deposition capability. In the embodiment of FIG. 2, an exemplary electrospinning platform 200 is illustrated which comprises a controller 202, a pressure transmitter 204, a solution container 208 for containing a suitable solution to be electrospun, a main reservoir 210, a pump 212, and a high voltage source 214. As can be seen in the alternative view of platform 200 in FIG. 2, the bottom of platform 200 comprises a spinneret 216 and a translation stage 218. Translation stage 218 permits for movement of spinneret 216 in at least a two-dimensional manner.

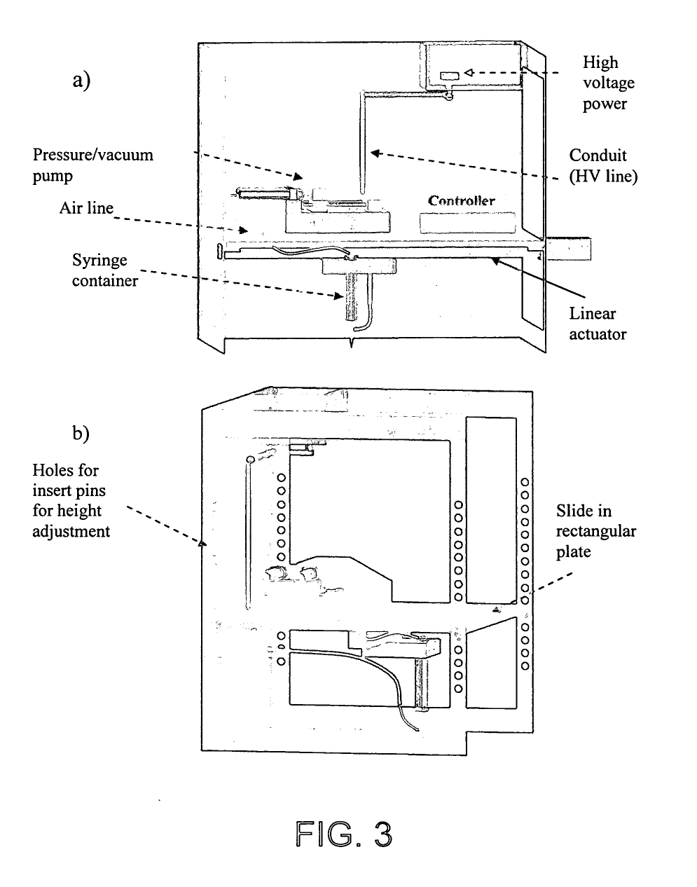

It should be noted that the present invention is not just limited to embodiment where a single nanofiber is deposited. Rather, electrospinning platforms with the capability of depositing one or more nanofibers can be utilized in the present invention. Electrospinning platforms shown in FIG. 2 have open sides for illustration purpose only. In reality, the platforms should be sealed at all sides and should seal off the solution casting machine from the ambient atmosphere when they are in use. FIGS. 3(a) and 3(b) illustrate two additional views of another embodiment of an electrospinning platform that can be utilized in conjunction with the present invention. Again, the electrospinning platforms shown in FIGS. 3(a) and 3(b) have open sides for illustration purpose only. In reality, the platforms should be sealed at all sides and should seal off the solution casting machine from the ambient atmosphere when they are in use.

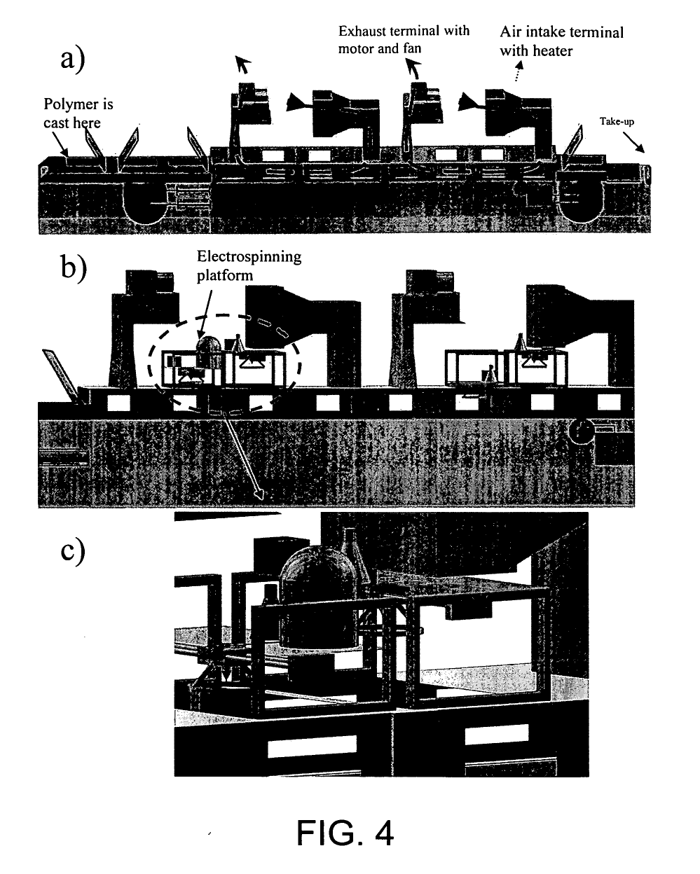

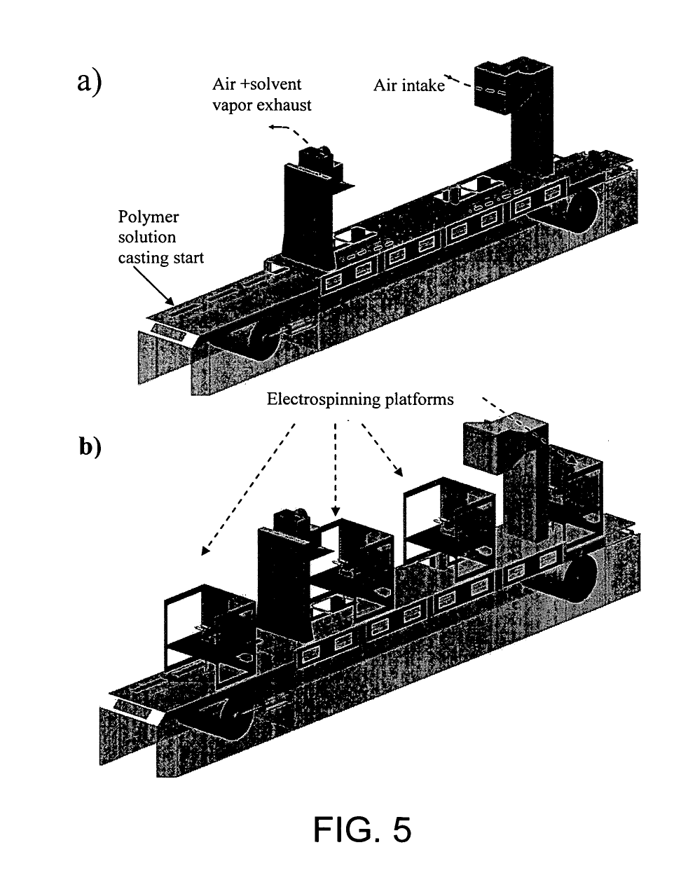

Solution casting machines offer a practical solution and provide a platform for continuous production of webs of nanofibers directly on the rotating carrier belts or on the cast polymer solutions for creating hybrid multilayered film structures. FIGS. 4(a), 4(b) and 4(c) are illustrations of a commercial solution casting machine and an integrated version according to the present invention using multiple electrospinning platforms according to the embodiment of FIG. 2. FIGS. 5(a) and 5(b) are illustrations of a commercial solution casting machine and an integrated version according to the present invention using multiple electrospinning platforms according to the embodiment of FIGS. 3(a) and 3(b).

There are many adjustable process variables of solution casting, or melt cast, processes that could be useful for better control of the electrospinning process. For instance, the temperature of the inlet air and under-bed heaters is adjustable—facilitating temperature profiling along the length of the machine. The ability to control the air temperature is important for electrospinning since temperature of the air influences the drying behavior of the nanofibers. By raising the air inlet temperature, it is possible to reduce the distance between the spinneret and the receiver carrier belt. FIG. 4(a) illustrates a solution casting machine with a parallel air flow design over the carrier. Other designs utilizing air impingement drying or steam spray are also available commercially.

Another variable is the speed of the air over the carrier. An increase in air speed can also accelerate the drying of the nanofibers and facilitate fast removal of the solvent vapor from the environment. Usually, the solvent vapors in the exhaust air pass through an exhaust duct and are stripped off from the exhaust air by a solvent recovery unit. In addition, all commercial solution casting machines are equipped with Lower Explosion Level (LEL) sensors. These auxiliary capabilities of the solution casting process are important since most current electrospinning processes are carried out in open atmosphere and do not conform to health and/or safety standards.

Another advantage of using a solution casting, or melt casting, carrier platform for electrospinning is the adjustable line speed. This brings in a collection area motion capability to the electrospinning process. There are solution casting, or melt-casting, machines that are up to 300 ft in length and can attain carrier speeds of from about 100 to about 1000 ft/min. These speeds are high enough to cause alignment of the nanofibers which is important for some applications. For such high speed applications, conductive polymer films can, in one embodiment, be used as carrier substrates and coated with aligned nanofibers. It is also possible to coat the top layers of very thin solution cast polymers with aligned nanofibers in high speed operation modes. In this mode of operation, the residence time would not be enough to spin the nanofibers on the cast solution before the solvent is evaporated. In such situations a very thin layer of liquid can be coated onto a carrier film, thus lowering the residence time requirements in the chamber. In another operational mode, the thickness of the dry polymer film, which can be about 2 to 3 microns, permits fibers and/or nanofibers to be spun on the dry film which is cast on the conductive carrier (steel, or a conductive polymer film) belt. In one embodiment, the belt can be rotated in an endless fashion until the desired electrospun layer thickness is achieved.

The present invention is capable of producing thin nanofiber reinforced hybrid films. These films comprise a uniform polymer film layer that is coated with, or has embedded therein, one or more layers of fibers and/or nanofibers. While not limited thereto, the thickness of such films can, in one embodiment, range from a couple of micrometers to several thousands of microns. Films made in accordance with the present invention could, for example, be used as solar sails for a spacecraft.

Additionally, the present invention makes it possible to render nonconductive polymer films conductive by embedding conductive polymer nanofibers in a nonconductive polymer film.

The hybrid films of the present invention could also be useful in manufacturing hybrid membranes comprising nonporous and nano-porous layers of different polymers and morphologies. Such materials are useful in areas of selective chemical reactivity, solid support catalysts, membrane supported smart materials, and membranes for immobilizing biological and pharmacologically active agents and molecules. In addition with a judicious choice of materials, surfaces exhibiting extreme hydrophobicity or hydrophilicity can be produced.

Returning to the discussion of the fiber and/or nanofiber structures made possible by the present invention, these fibrous structures can be embedded or simply reside on the surface of the film by adjusting material and process variables of both the electrospinning and solution casting, or melt casting, process. The temperature of the melt cast target layer and the electrical potential difference between the electrospinning solution and the receiving melt cast target are, in one instance, important parameters. In a solution cast embodiment, the amount of solvent remaining in the cast target solution layer and the electrical potential difference between the electrospinning solution and the receiving target (e.g., a cast base solution layer) are, in one instance, important parameters. In one embodiment, the electrospun nanofibers should have a higher melting temperature or glass transition temperature than that of the solution cast, or melt cast, film. Otherwise, the electrospun fibers would melt and loose their morphology. If the cast layer is mostly in the liquid form, the fibers and/or nanofibers under the influence of an electrical field overcome the surface tension of the solution, or melt, cast base film and penetrate into the film as much as the viscosity of the base film allows. If the nanofibers are spun on a solution, or melt, cast target that has released most of its solvent, the fibers and/or nanofibers can not penetrate into the base layer and simply will reside on or in close proximity to the surface of the base film.

In addition, as the solvent evaporates from a solution cast base target solution, the conductivity of the target decreases and the nanofibers travel slower towards the target due to unfavorable electrical potential conditions. The location of the electrospinning platforms along the casting, or the melt film, line can, in some embodiments, be important in determining whether the nanofibers will be embedded or will simply reside on the surface of the target layer traveling underneath the electrospinning platform(s). Control of the rate of evaporation (in solution casting embodiments) and/or temperature can also be used to develop gradient structures where the nanofibers may be placed at different depths in a thickness direction in the base film. This concept is possible by, in one instance, partially drying solution cast films before fibers and/or nanofibers are electrospun onto the films.

Hybrid films are investigated using scanning electron microscopy (SEM) and optical microscopy (OM). SEM images have a characteristic three-dimensional appearance and are useful for judging the surface structure of the films. If all the fibers are on the surface, SEM shows uniform well defined fibers. If the fibers are partially embedded, SEM shows bright and dark regions of fibers indicating slightly embedded and on-surface regions; respectively.

In another instance, if the fibers are embedded but still very close to the surface of the film, SEM can detect faint impressions of the fibers. If the nanofibers are embedded deep into the film, SEM cannot detect any fiber image. In such a case, optical microscopy, either in the transmission mode or dark and/or bright field reflection mode, can detect the nanofibers embedded in the film. Atomic force microscopy (AFM) is another characterization tool useful for characterizing the embedded fibers. The above-mentioned concept can be easily adapted to continuous operation by real time detection of the solvent concentration of the solvent in the traveling film and by control of temperature of the carrier from below (conduction) and from above (convection) the desired concentration in the film can be achieved underneath the electrospinning platform(s). This will make continuous nano-manufacturing possible.

The electrical potential difference between the electrospinning solution and the receiving target determines how strongly the nanofibers will impinge onto the base solution cast, or melt cast film, layer. Increasing the electrical potential between the electrospinning solution and the base liquid target will facilitate fiber and/or nanofiber penetration into the solution cast, or melt cast, layer. On the other hand, nanofibers can be placed gently on the base solution cast, or melt cast, target by adjusting the electrical potential difference between the solution and the target.

The nature of the solution cast, or melt cast film, layer and electrospun fibers (viscosity, surface tension, etc.) is one controlling factor for embedding or coating of the films with nanofibers. Depending on the surface tension, temperature and viscosity, the cast layer may exhibit resistance to the wetting and impregnating of the fiber and hence penetration of the fiber into the film. If different polymer layers are employed for melt casting and electrospinning, one can manufacture hybrid polymer films with different layers of polymers and morphologies along the thickness direction. If a single polymer is used in the process, multiple layers of the same polymer with different morphologies, i.e. uniform thin film and fibrous structures, can be formed along the thickness direction of the film. However, the temperature and/or solvent used for film casting should be chosen so that it does not fuse and melt, or dissolve, the nanofibers.

Due to the present invention, applications where it is desirable to control surface friction properties via the control of chemical and physical attributes of the films with embedded nanofibers, can be obtained. In another application one can create electro-active structures where the nanofiber orientation with respect to the embedded plane can be altered by electrical means. This will offer active control of surface properties of the materials.

In another application, protrusions of nanofibers can be formed and such protrusions may/can be used to dissipate heat from the main body of structures attached to a conductive (electrical and/or thermal) film on which they are embedded. In another application the application of nanofibers can be used in membrane applications where selective separation of certain chemical species is desired. In another application, the nanofibers can be immobilized on a substrate and these structures can be used as catalysts when the nanofibers are embedded, coated and/or impregnated with one or more appropriate inorganic or organic compounds.

In another application the membranes needed to construct the fuel cells can be produced by this hybrid process. Proton conducting membranes reinforced with nanofibers could help with high temperature conductivity problems. The porous nature of such membranes would also help with the wetting of the membrane and its water retention.

Using the present invention, it is possible to form physical and chemical protective layers on thin solvent cast films used for commodity or high technology applications. These films will be very light in weight.

Due to the present invention, a solution cast, or melt cast film, layer can serve as a substrate for holding electrospun nanofiber webs. This is important for integrating photonics into textiles and clothing. Wearable photonics such as fiber optic sensors and integrated smart textile structures and the developments in various flexible photonic display technologies as well as current communication apparel and optical fiber fabric displays will benefit from this technology.

The present invention could also be used to produce photonic structures and/or yield an improved method for the fabrication of such structures. In one such instance, the present invention could be used in whole, or in part, to produce arrays of tiny coils arranged to make a structure with negative dispersion at useful frequencies. The useful frequency range can be chosen by adjusting the dimensions of the coils. The negative dispersion material interacts with one of the circularly polarized photons, while the opposite circular polarization does not interact. The coils can be coated with metals, either completely or partially, to provide electrical conductivity or polarizability. Such coils can be made by utilization of the electrically driven bending instability of an electrospinning jet. In such a case, the present invention permits the creation of a substrate in the form of a cast sheet, which can hold the coils in useful orientations, i.e. at optimal angles and spacings in three-dimensional space, on the sheet.

In another embodiment, the fibers and/or nanofibers used in the present invention can be made by other suitable methods. Such methods include, but are not limited to, wet spinning, dry spinning, melt spinning; gel spinning and nanofibers by gas jet (NGJ). As mentioned above, electrospinning is particularly suitable for fabricating fibers of the present invention inasmuch as it tends to produce the thinnest (i.e., finest denier) fibers of any of the foregoing methods. Electrospinning techniques are described in U.S. Pat. Nos. 4,043,331; 4,878,908; and 6,753,454, which are hereby incorporated by reference in their entireties.

Another particularly effective method for producing nanofibers of the present invention comprises the nanofibers by gas jet method (i.e., NGJ method). Techniques and apparatuses for forming fibers via NGJ are described in U.S. Pat. Nos. 6,382,526; 6,520,425; and 6,695,992, which are hereby incorporated by reference in their entireties.

Briefly, the method comprises using a device having an inner tube and a coaxial outer tube with a sidearm. The inner tube is recessed from the edge of the outer tube thus creating a thin film-forming region. Polymer melt is fed in through the sidearm and fills the empty space between the inner tube and the outer tube. The polymer melt continues to flow toward the effluent end of the inner tube until it contacts the effluent gas jet. The gas jet impinging on the melt surface creates a thin film of polymer melt, which travels to the effluent end of tube where it is ejected forming a turbulent cloud of nanofibers.

In still another embodiment, the present invention also permits the addition, sequestration or coating of the one or more nanofiber layers of the present invention with one or more chemical reagents, biological cells and organelles, biomolecules, and/or therapeutic substances.

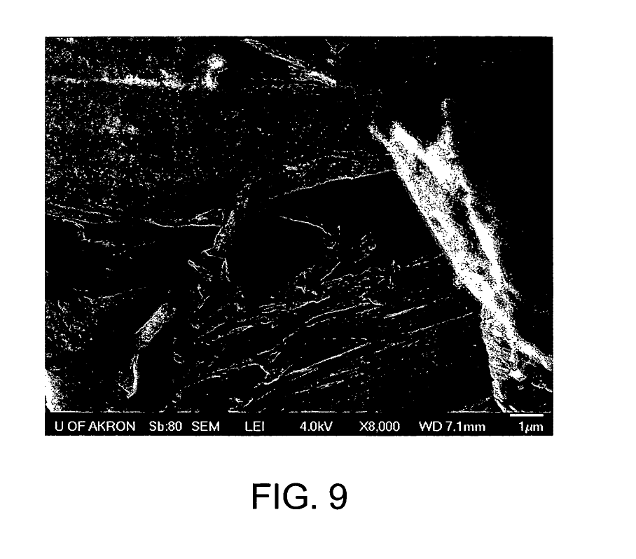

In still another embodiment, the present invention can include one or more nanofiber layers where the nanofibers making up one or more of the nanofiber layers are beaded nanofibers (see FIG. 9). In this instance any portion of the nanofibers, or even all the nanofibers, are beaded. In another embodiment, some or all of the nanofibers contained within the structures of the present invention are coiled nanofibers.

In another embodiment, the present invention combines an electrospinning process with that of standard melt casting process to produce functional films that are fully and/or partially embedded nanofibers. This process differs from solution cast embodiments where the nanofibers are delivered to the cast polymer solutions and/or monomers and subsequently solidified by solvent evaporation or affecting reaction in one or both media through reaction including polymerization.

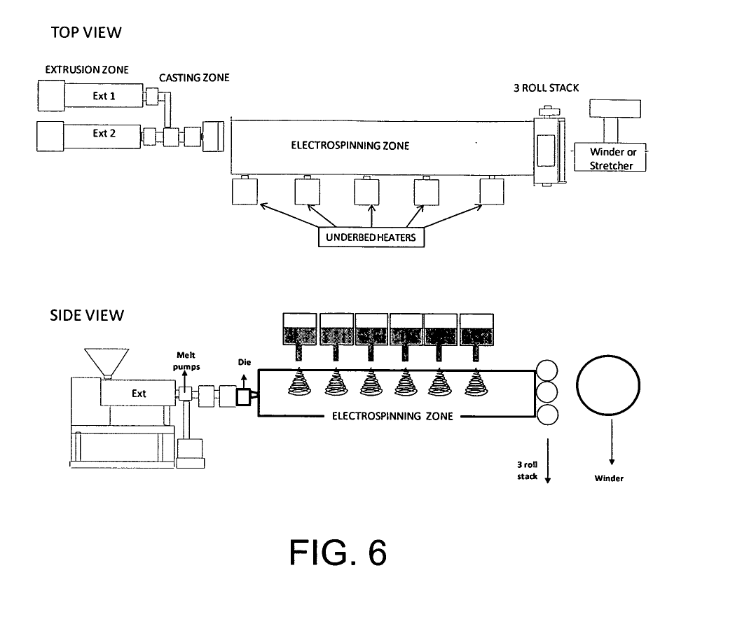

The present invention is unique as it substitutes the relatively costly solution/reactant film casting which requires solvent and solvent recovery as part of the process and simply uses cast molten film and maintains the molten film in this state with under-bed heaters on the carrier while the nanofibers are deposited onto it. The solidification is affected by simply cooling the film to room temperature as it transports along the casting system. The conceptual schematic of the process is given in FIG. 6.

In this process, one or more molten sheets of polymer is delivered by one or more multiple screw extruders via one or more metering pumps to a heated sheet casting. One function of the metering pump is to deliver a steady state melt stream to the heated sheet casting die connected through a heated conduit. The molten sheet of polymer stream is deposited on a heated carrier where it is prevented from solidifying by built-in under-bed heaters while the nanofibers produced by a multi-nozzle rasterizing electrospinning platform are driven into the molten film. The films are then cooled in subsequent stages of the casting system and collected via a winder or by going through uniaxial stretching and tenter frame processes. This is done as a means of further processing and orientating embedded nanofibers at desired directions to facilitate the development of nanofiber embedded fibers with anisotropic properties provided by the preferred orientation of the matrix film, embedded nanofibers or both.

In another embodiment, the present invention relates to a method for producing hybrid materials of thin polymer films with single, laminated, complete and/or partially embedded nanofibers to obtain products with unique functional properties. In one embodiment, the present relates to a hybrid process that utilizes both melt casting and electrospinning to produce nanofiber embedded functional films. In still another embodiment, the process of the present invention involves nanofiber-containing products that are formed by producing a plurality of nanofibers via one or more nanofiber producing nozzles; depositing such nanofibers onto a melt cast polymer film; and either partially and/or completely embedding such nanofibers into the melt cast polymer film via one or more electrical forces. Subsequently, the cast molten film is cooled thereby immobilizing the partially and/or completely embedded nanofibers into the melt cast polymer film. In still another embodiment, the nanofibers of the present invention can possess various properties, or functionalities, including, but not limited to, electrical conductivity, transparency and/or bio-functionality. Optionally, the melt cast film is delivered to the portion of the carrier that maintains the film in the molten state by a built-in heating system.

### Material Design Considerations:

Base Film: In one embodiment, the present invention utilizes polymers with low melt viscosities in order to pose minimal resistance to the penetration of the nanofibers under the action of the electrostatic forces. Such polymers include, but are not limited to, nylon, nylon n family of polymers, nylon n/m family of polymers (e.g., Nylon 6 and Nylon 6,6), aliphatic and aromatic polyesters (e.g., polyethylene terephthalate, polybutylene terephthalate, and polyethylene naphthalate), biodegradable polymers, any other thermoplastic polymer composition that exhibits medium to low viscosity (e.g., a viscosity of less than about 10,000 Pa·s, or even less than about 10 Pa·s), low molecular weight polymers (e.g., polymers having average molecular weights of less than about 50,000, or even less than about 10,000), or suitable combinations of two or more thereof. Cyclic low molecular weight precursors of polycarbonates or similar materials may also be used for this purpose.

Nanofibers: One embodiment uses one or more nanofiber materials selected from a wide class of polymers and prepolymers or mixtures of polymers. This is due to the fact that any polymer that can be dissolved into a solution can be made into spinnable solution. The chosen polymers are typically prepared in a solution by dissolving the desired polymer, or polymers, into a suitable solvent that is selected for its ability to evaporate during the course of spinning. The spinning solutions can be blended with other soluble, or insoluble, polymers as well as solid suspended particles with functionalized materials such as nanoparticles including, but not limited to, metal nanoparticles, inorganic nanoparticles, organic nanoparticles, nano-material precursors, nanomaterials, nanofibers, or a combination of two or more thereof (e.g., carbon based nanotubes and the like). This provides a wide range of functionalities to the final films. Applications of note include electrical, biological, and mechanical functionalities.

Advantages: Some advantages of the process of the present invention involve allowing the development of asymmetric film manufacturing with one side of the film exhibiting one functionality (electrical, chemical, biological, tribological, or mechanical) provided by the prevalence of nanofibers and the other side of another provided by the polymer film.

### Examples

Nylon Film Embedded with Pan Nanofibers:

FIG. 7 is a scanning electron microscope (SEM) image of PAN nanofibers electrospun onto a melt cast Nylon film. The fibers fuse to the molten film and form a single structure along with the film.

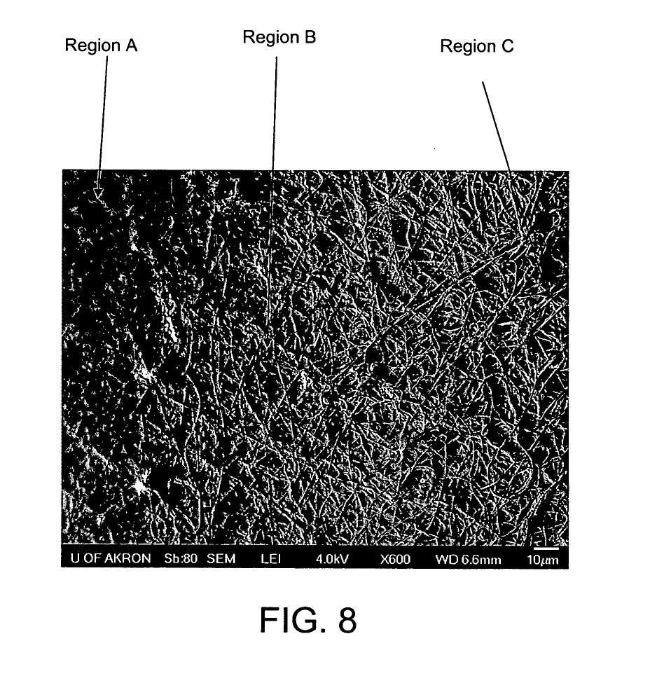

FIG. 8 is a scanning electron microscope (SEM) image of a melt cast Nylon film with PAN nanofibers electrospun thereon. Region ‘A’ of the film has a much lesser viscosity due to higher temperature than Regions ‘B’ and ‘C’. Thus in Region ‘A’, most of the fibers have penetrated the film and one can see faint impressions of nanofibers. Region ‘B’ has a higher viscosity than Region ‘A’ and lesser than Region ‘C’. In Region ‘B’, the fibers seem to be partially embedded on the surface instead of completely penetrating the film. Region ‘C’ has the highest viscosity due to low temperature and thus there is a higher density of fibers on the surface.

FIG. 9 is a scanning electron microscope (SEM) image of a cross-section of a Nylon film with PAN nanofibers electrospun thereon. The fibers maintain their structural morphology inside the molten film.

PCL Film Embedded with Pan Nanofibers:

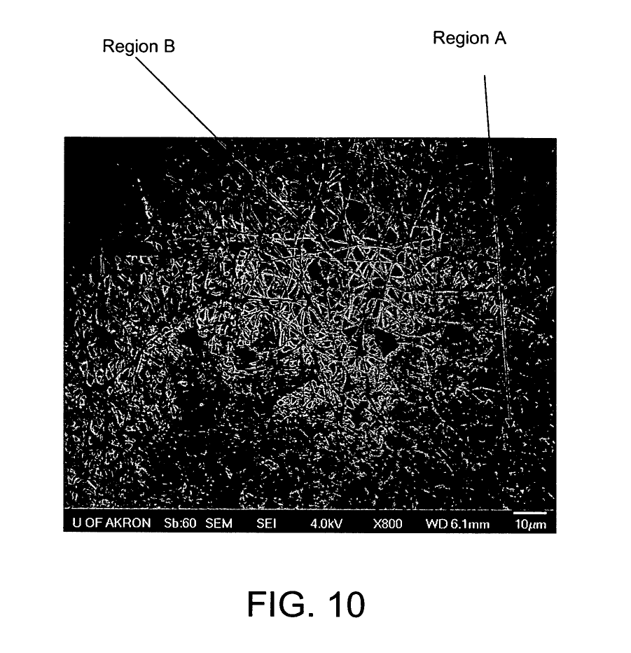

FIG. 10 is a scanning electron microscope (SEM) image of a melt cast PCL film with PAN nanofibers electrospun thereon. FIG. 10 depicts two Regions ‘A’ and ‘B’, with the former having a lesser viscosity than the later. Most of the nanofibers seem to penetrate the Region ‘A’ with faint visible fiber impressions. Region ‘B’ has most of the fibers on the surface, but fuses with the molten film forming a single structure.

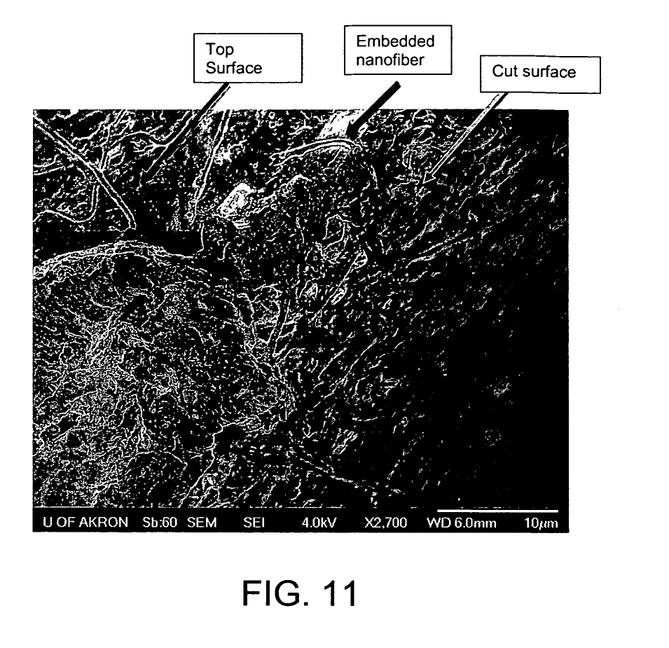

FIG. 11 is a scanning electron microscope (SEM) image of a cross-section of a PCL film with PAN nanofibers electrospun thereon. Again the fibers seem to maintain their structural morphology after penetrating the molten film.

PET Film Embedded with Pan Nanofibers:

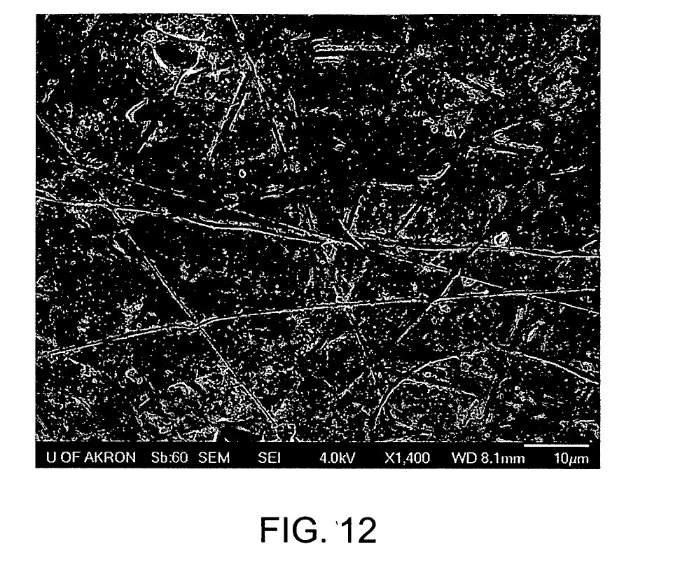

FIG. 12 is a scanning electron microscope (SEM) image of a melt cast PET film with PAN nanofibers electrospun thereon. Some fibers are seen partially embedded on the surface of the film, while most of the fibers have penetrated the film.

In light of the above, the present invention is directed to, in one embodiment, a method for producing a nanofiber-polymer film combination from the combination of a solution casting, or melt casting, process with an electrospinning process. As would be appreciated by those of skill in the art, the present invention can utilize any suitable solution casting, or melt casting, process to form a polymer, or even monomer, layer or film upon which are deposited fibers (e.g., nanofibers) via any suitable electrospinning process. Given this, the present invention is not limited to just the electrospinning devices disclosed herein. Rather, any suitable electrospinning platform can be utilized in conjunction with the present invention. In one instance, suitable electrospinning devices, or platforms, contain any suitable number of electrospinning nozzles, jets, etc.

Although the invention has been described in detail with particular reference to certain embodiments detailed herein, other embodiments can achieve the same results. Variations and modifications of the present invention will be obvious to those skilled in the art, and the present invention is intended to cover in the appended claims all such modifications and equivalents.

What is claimed is:

1. A method for producing a nanofiber-polymer film combination, the method comprising the steps of:
(A) producing a polymer film via a melt casting process, wherein the melt cast polymer film is receptive to one or more layers of nanofibers;
(B) depositing one or more layers of nanofibers on the melt cast polymer film.

2. The method of claim 1, wherein the one or more layers of nanofibers have an average diameter in the range of 3 nanometers to about 3,000 nanometers.

3. The method of claim 1, wherein the one or more layers of nanofibers have an average diameter in the range of about 7 nanometers to about 1,000 nanometers.

4. The method of claim 1, wherein the one or more layers of nanofibers have an average diameter in the range of about 10 nanometers to about 500 nanometers.

5. The method of claim 1, wherein the polymer film is formed nylon, nylon n family of polymers, nylon n/m family of polymers, aliphatic and aromatic polyesters, biodegradable polymers, a thermoplastic polymer composition that exhibits medium to low viscosity, low molecular weight polymers, or suitable combinations of two or more thereof.

6. The method of claim 5, wherein the polymer film is formed from a polycaprolactone (PCL).

7. The method of claim 1, wherein the nanofibers are formed from any polymer compound that can be electrospun.

8. The method of claim 7, wherein the nanofibers are formed from polyethylene oxide.

9. The method of claim 1, wherein the nanofibers are formed from any polymer compound that can be subjected to a nanofiber by gas jet process.

10. The method of claim 1, wherein at least two nanofibers layers are sequentially deposited on the polymer film, wherein each nanofiber layer is individually formed by one or more distinct electrospinning apparatuses.

11. The method of claim 1, wherein the nanofiber-polymer film combination further comprises one or more nanoparticles selected from metal nanoparticles, inorganic nanoparticles, organic nanoparticles, nano-material precursors, nanomaterials, nanofibers, or a combination of two or more thereof.

12. A product formed via the method of claim 1.

13. A method for producing a nanofiber-polymer film combination, the method comprising the steps of:
(a) producing a polymer film via a melt casting process, wherein the melt cast polymer film is receptive to one or more layers of nanofibers;
(b) subjecting the melt cast polymer film to at least one heating zone;
(c) depositing one or more layers of nanofibers on the melt cast polymer film.

14. The method of claim 13, wherein the one or more layers of nanofibers have an average diameter in the range of 3 nanometers to about 3,000 nanometers.

15. The method of claim 13, wherein the one or more layers of nanofibers have an average diameter in the range of about 7 nanometers to about 1,000 nanometers.

16. The method of claim 13, wherein the one or more layers of nanofibers have an average diameter in the range of about 10 nanometers to about 500 nanometers.

17. The method of claim 13, wherein the polymer film is formed nylon, nylon n family of polymers, nylon n/m family of polymers, aliphatic and aromatic polyesters, biodegradable polymers, a thermoplastic polymer composition that exhibits medium to low viscosity, low molecular weight polymers, or suitable combinations of two or more thereof.

18. The method of claim 17, wherein the polymer film is formed from a polycaprolactone (PCL).

19. The method of claim 13, wherein the nanofibers are formed from any polymer compound that can be electrospun.

20. The method of claim 19 wherein the nanofibers are formed from polyethylene oxide.

21. The method of claim 13, wherein the nanofibers are formed from any polymer compound that can be subjected to a nanofiber by gas jet process.

22. The method of claim 13, wherein at least two nanofibers layers are sequentially deposited on the melt cast polymer film, wherein each nanofiber layer is individually formed by one or more distinct electrospinning apparatuses.

23. The method of claim 13, wherein the nanofiber-polymer film combination further comprises one or more nanoparticles selected from metal nanoparticles, inorganic nanoparticles, organic nanoparticles, nano-material precursors, nanomaterials, nanofibers, or a combination of two or more thereof.

24. A product formed via the method of claim 13.
